(19) United States
(12) Patent Application Publication
(10) Pub. No.: US 2001/0027779 A1
(43) Pub. Date: Oct. 11, 2001

(54) FUEL SUPPLY APPARATUS

(76) Inventors: SHINGO IWAI, TOKYO (JP); SEIJI TSUTSUI, TOKYO (JP)

Correspondence Address: ROBERT J SEAS, SUGHRUE MION ZINN MACPEAK & SEAS, 2100 PENNSYLVANIA AVENUE NW, WASHINGTON, DC, 200373202

(21) Appl. No.: 09/154,855

(22) Filed: Sep. 17, 1998

(30) Foreign Application Priority Data
Feb. 25, 1998 (JP) 10-43065

(51) Int. Cl. F02M 37/04

(52) U.S. Cl. 123/497

(57) ABSTRACT

A fuel supply apparatus comprising a housing 10a made of a molded polymer material and containing therein a filter element 8 of a fuel filter 10 for filtering the fuel from the fuel pump 4.b and a supply passage 12 for introducing the filtered fuel from the fuel filter 10 to an engine. A pressure regulator 9 is provided for opening a valve 13 when the fuel pressure within the supply passage 12 is equal to or more than a predetermined pressure to return an excess amount of the fuel to the fuel tank 1 for regulating the fuel pressure within the supply passage 12. A a check valve 13 is also integrally incorporated in the supply passage 12 for preventing the reverse flow of the fuel from the engine.

### BACKGROUND OF THE INVENTION

This invention relates to a fuel supply apparatus in which the fuel pump and the fuel filter disposed within a fuel tank of a vehicle or the like are arranged in an integral structure.

FIG. 5 is a sectional side view of a conventional fuel supply apparatus in which a fuel pump and a fuel filter are arranged in an integral structure shown in Japanese Patent Laid-Open No. 8-121282, for example, FIG. 6 is a schematic diagram of a fuel supply system and FIG. 7 is a sectional view of a conventional fuel pump disclosed in Japanese Patent Laid-Open No. 63-272994.

In the figures, 1 is a fuel tank having an opening at its top surface. 2 is a bracket oil-tightly mounted to the top opening of the fuel tank 1, 3 is a support post extending from the bracket 2 toward the bottom surface of the fuel tank 1, 4 is an electric type fuel pump held on the support post 3, 5 is a check valve disposed in the discharge port 4a of the fuel pump 4 and 6 is a filter mounted to the suction port 4b of the fuel pump 4.

Reference numeral 7 is a fuel filter having a supply port 7a to an engine mounted oil-tightly to the bracket 2 is positioned outside of the fuel tank 1 and a suction port 7b of the fuel filter 7 is connected to the discharge port 4a of the fuel pump 4. The housing 7c of the fuel filter 7 is made of a molded resin and having a filter element 8 therein. 9 is a pressure regulator which opens the valve when the fuel supply pressure to the engine through a communication passage 7d exceeds a predetermined value to return an excess amount of fuel to the fuel tank 1 to maintain the fuel supply pressure at a constant range.

Then, the operation of the conventional vehicular fuel supply apparatus will be described. When the key switch of the vehicle is turned on for starting the engine, the fuel pump 4 is driven to pressurize the fuel to 200-300 KPa (Kilo-Pascals) and pumped through the check valve 6 from the fuel supply port 7a to the engine. The pressure of the fuel supplied to the engine by the pressure regulator 9 connected to the downstream of the filter element 8 within the fuel filter 7 through the communication passage 7c is maintained at a constant range. When the fuel pump 4 is stopped by turning off the switch key, the check valve 5 prevents the reverse flow of the fuel from the fuel filter 7 to the fuel pump 4 thereby maintaining the fuel pressure in the fuel filter 7 and the supply port 7a.

In the conventional fuel supplying apparatus of the conventional design, the check valve 5 is disposed upstream of the fuel filter 7, so that even when the vehicle switch key is turned off to stop the engine, the fuel within the fuel filter 7 is maintained at a high pressure, so that the housing 7c of the fuel filter 7 is always subjected to a stress due to the high pressure fuel. Therefore, the configuration and the resin material must be selected so that the housing endures the constant stress during an extended period of operating life time of the vehicle, resulting in a high cost.

### SUMMARY OF THE INVENTION

Accordingly, an object of the present invention is to provide a fuel supply apparatus free from the above-discussed problems of the conventional apparatus.

Another object of the present invention is to provide a fuel supply apparatus in which, in view of the fact that the time in which the fuel is pumped for driving engine (driving the vehicle) is a few tenths of the vehicle operating life time, the stress of the high pressure fuel applied to the housing 7c is limited to only during the engine operation, whereby the selection of the configuration and the resin material for the housing 7c is made easy so that the fuel supply apparatus can be made inexpensive.

With the above objects in view, the fuel supply apparatus of the present invention comprises a housing made of a molded polymer material and containing therein a filter element of a fuel filter for filtering the fuel from the fuel pump, a supply passage for introducing the filtered fuel from the fuel filter to an engine, a pressure regulator for opening a valve when the fuel pressure within the supply passage is equal to or more than a predetermined pressure to return an excess amount of the fuel to the fuel tank for regulating the fuel pressure within the supply passage, and a check valve integrally incorporated in the supply passage for preventing the reverse flow of the fuel from the engine.

In the fuel supply apparatus of the present invention, the check valve may be disposed in a nipple portion at an end of the supply passage downstream of a branching point to the pressure regulator.

In the fuel supply apparatus of the present invention, the check valve may be disposed between the fuel filter and a branching point to the pressure regulator.

In the fuel supply apparatus of the present invention, the housing of the fuel filter may be composed of a main housing surrounding and holding the filter element and an upper housing made of a molded polymer material joined to define an oil-tight fuel filter, the main housing integrally defining a fuel pump holding portion, and wherein the pressure regulator is connected and mounted to the supply passage disposed in the upper housing.

### BRIEF DESCRIPTION OF THE DRAWINGS

The present invention will become more readily apparent from the following detailed description of the preferred embodiments taken in conjunction with the accompanying drawings, in which:

FIG. 1 is a sectional side view of the fuel supply apparatus of the first embodiment of the present invention;

FIG. 2 is a schematic diagram of the fuel supply system of the first embodiment;

FIG. 3 is a sectional side view of the fuel supply apparatus of the second embodiment of the present invention;

FIG. 4 is a schematic diagram of the fuel supply system of the second embodiment;

FIG. 5 is a sectional side view of a conventional fuel supply apparatus;

FIG. 6 is a schematic diagram of a fuel supply system of the conventional fuel supply apparatus; and

FIG. 7 is a sectional view of a conventional fuel pump.

### DETAILED DESCRIPTIN OF THE PREFERRED EMBODIMENTS

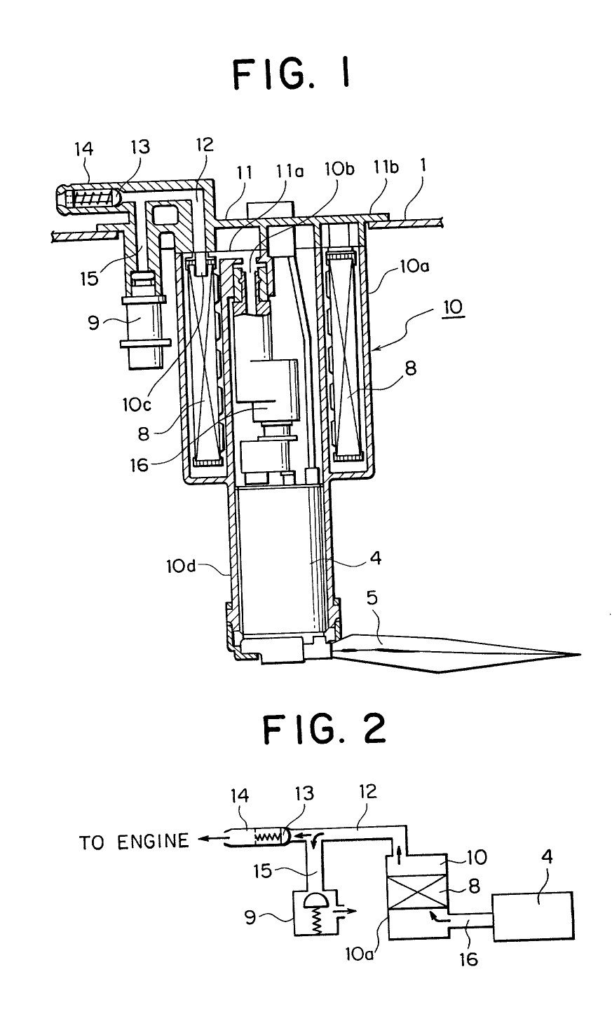

FIG. 1 is a sectional side view of the fuel supply apparatus of the first embodiment of the present invention and FIG. 2 is a schematic diagram of the fuel supply system of the first embodiment.

In these figures, reference numerals 1, 4, 8 and 9 designate the coimponents similar to those of the conventional apparatus as above described. Reference numeral 10 is a fuel filter having disposed within a main housing 10a made of a molded resin material of a polymer material a filter element 8 and an inlet 10b and outlet 10c for the fuel filter 10 are provided. Also, a pump holding portion 10d is provided at a downwardly extended portion of a main housing 10a. Reference numeral 11 is an upper housing of the fuel filter 10 made of a molded resin material, which, after the filter element 8 is inserted into the main housing 10a, the predetermined portions of the abutting portion 11a of the main housing 10a and the upper housing 11 are oil-tightly sealed by the thermal welding or the like so that the fuel flows within the fuel filter 10 from inlet 10b→the filter element 8→the outlet 10c. At the same time, the outer edge of the upper housing 11 is provided with an integral bracket flange 11 b for mounting the fuel supply apparatus to the fuel tank 1.

Reference numeral 12 is a supply path communicating with the outlet 10c of the fuel filter 10 for supplying liquid fuel to the engine. This supply path 12 is also integrally formed in the upper housing 11. Reference numeral 13 is a check valve disposed to the nipple portion 14 at the terminal end of the supply path 12 for preventing the reverse flow of the liquid fuel from the engine to the fuel filter 10.

The supply path 12 and the outlet 10c are concurrently weld-connected when the upper housing 11 is heat welded in an oil-tight manner to the opening of the main housing 10a. Reference numeral 15 is a communication passage shunted from the supply path 12, its tip having mounted thereon the pressure regulator 9 and arranged so that the excess amount fuel from the pressure regulator 9 is returned to the fuel tank. Reference numeral 16 is a communication pipe connecting the fuel pump 4 and the inlet 10b of the fuel filter 10.

In the fuel supply apparatus arranged as described above, when the key switch of the vehicle is turned on to drive the fuel pump 4, the fuel pressurized to 200-300 KPa (Kilo-Pascals) is pumped from the inlet 10b of the fuel filter 10 to the outlet 10c through the filter element 8. During this process, the filter element 8 filters the dust or any foreign matters entrained in the fuel. The filtered liquid fuel is supplied to the engine through the supply path 12 and through the check valve 13. The pressure regulator 9, which is disposed to the communication passage 15 shunted from the supply path 12 for maintaining the fuel pressure in the engine within a constant range, discharges an excess amount of fuel in the supply path 12 to the fuel tank 1 upon an excessive pressure supply from the fuel pump 4 and the pressure increase due to decrease in the fuel consumption of the engine. When the key switch is turned off and the fuel pump 4 is stopped, the check valve 13 maintains the fuel pressure in the engine portion. However, since the pressurized liquid fuel in the fuel filter 10 is drained through from the fuel pump 4 due to the stoppage of the fuel pump 4, the inside of the fuel filter 10 is depressurized to a normal pressure, whereby the main housing 10a is relieved from the stress due to the pressurized liquid fuel when the vehicle is not being operated.

Therefore, when the engine is not operated, the stress of the high pressure liquid fuel acting on the main housing 10a can be eliminated. As compared to the life span of a vehicle, the operating time (the period during which the engine is driven) is only a few tenths, enabling the endurance period of the main housing 10a to be elongated as compared to the case where the stress of the high pressure liquid fuel is always applied. Particularly, when the resin molding configuration is such that the pump holding portion 10d is integrally formed to the main housing 10a, the flow of the resin during molding is complex and a local weak portion is generated in the main housing 10a, the configuration and the resin material can be easily selected to provide an inexpensive fuel supply apparatus.

Also, the arrangement in which the check valve 13 is disposed in the nipple portion 14 at the terminal end of the supply path 12 makes the provision of the check valve 13 easy.

Since the liquid fuel that becomes an excess amount because of the pressure adjustment of the supply path 12 by the pressure regulator 9 integrally connected to the supply path 12 is directly returned to the fuel tank 1, piping for the return pipe is not necessary, making the apparatus simple.

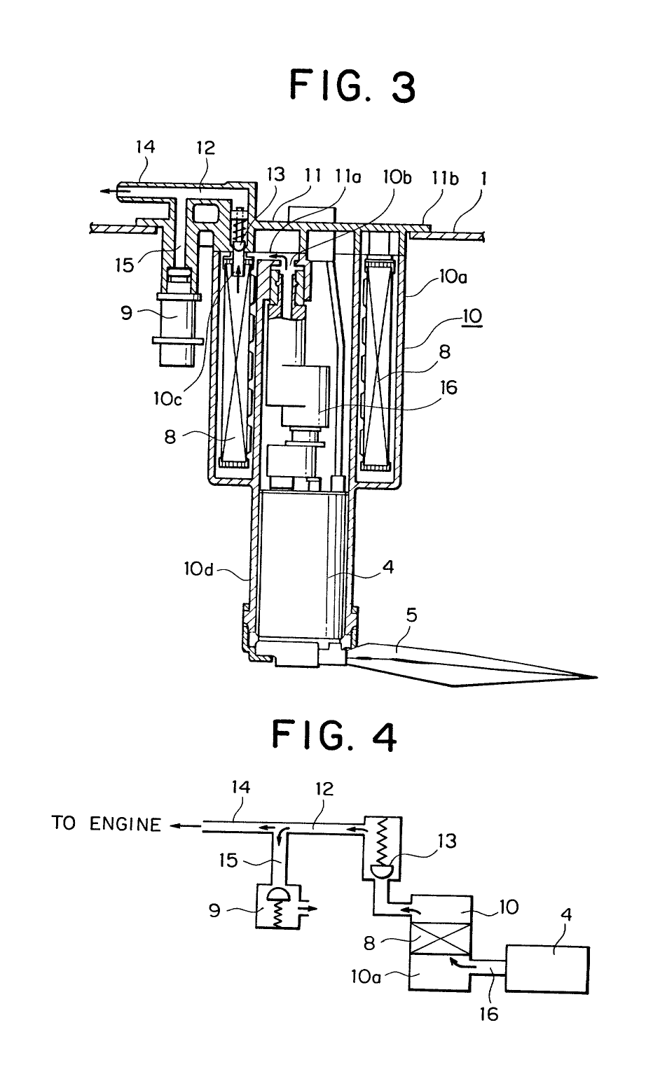

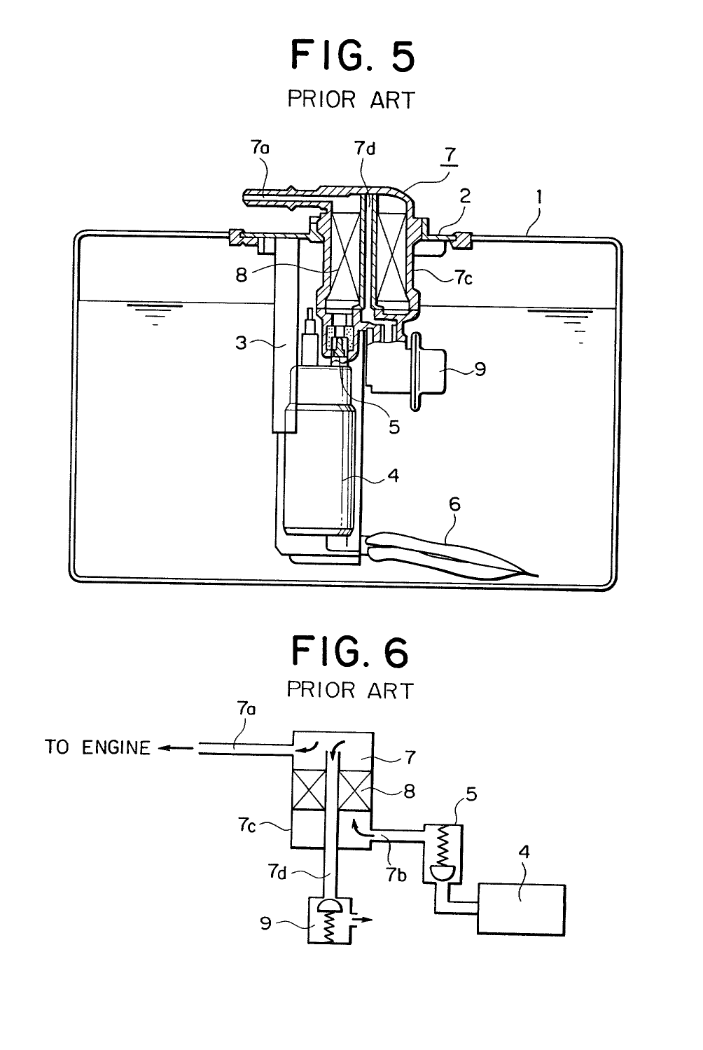

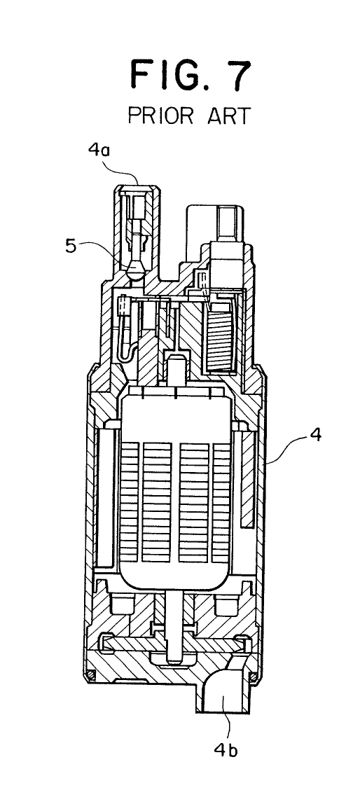

FIG. 3 is a sectional side view of the fuel supply apparatus of the second embodiment of the present invention and FIG. 4 is a schematic diagram of the fuel supply system of the second embodiment. In the figures, 1, 4, 8, 9-16 are those similar to the components explained in connection with the first embodiment.

The fuel supply apparatus of the second embodiment is provided with the check valve 13 disposed between the outlet 10c of the fuel filter 10 of the supply path 12 and the shunt of the connection passage 15 of the pressure regulator 9, the valve member of the check valve 13 being disposed in vertical position.

By positioning the check valve 13 in this position, the excessive liquid fuel on the engine side can be relieved without fail by the pressure regulator 9. Also, the operational instability of the check valve 13 due to the influence of the pipe connection between the engine and the supply path 12.

What is claimed is:

1. A fuel supply apparatus to be immersed in fuel within a fuel tank, comprising:
a fuel pump for pumping fuel;
a housing made of a molded polymer material and containing therein a filter element of a fuel filter for filtering said fuel from said fuel pump;
a supply passage for introducing the filtered fuel from said fuel filter to an engine;
a pressure regulator for opening a valve when the fuel pressure within said supply passage is equal to or more than a predetermined pressure to return an excess amount of the fuel to said fuel tank for regulating the fuel pressure within the supply passage, and
a check valve integrally incorporated in said supply passage for preventing the reverse flow of the fuel from the engine.

2. A fuel supply apparatus as claimed in claim 1, wherein said check valve is disposed in a nipple portion at an end of the supply passage downstream of a branching point to said pressure regulator.

3. A fuel supply apparatus as claimed in claim 1, wherein said check valve is disposed between said fuel filter and a branching point to said pressure regulator.

4. A fuel supply apparatus as claimed in claim 1, wherein said housing of said fuel filter is composed of a main housing surrounding and holding said filter element and an upper housing made of a molded polymer material joined to define an oil-tight fuel filter, said main housing integrally defining a fuel pump holding portion, and wherein said pressure regulator is connected and mounted to said supply passage disposed in said upper housing.

5. A fuel supply apparatus as claimed in claim 2, wherein said housing of said fuel filter is composed of a main housing surrounding and holding said filter element and an upper housing made of a molded polymer material joined to define an oil-tight fuel filter, said main housing integrally defining a fuel pump holding portion, and wherein said pressure regulator is connected and mounted to said supply passage disposed in said upper housing.

6. A fuel supply apparatus as claimed in claim 3, wherein said housing of said fuel filter is composed of a main housing surrounding and holding said filter element and an upper housing made of a molded polymer material joined to define an oil-tight fuel filter, said main housing integrally defining a fuel pump holding portion, and wherein said pressure regulator is connected and mounted to said supply passage disposed in said upper housing.
